(19) United States
(12) Patent Application Publication
(10) Pub. No.: US 2011/0168144 A1
(43) Pub. Date: Jul. 14, 2011

(54) Method and apparatus for operating standard gasoline-driven engines with a readily-available non-volatile fuel, thereby obviating the use of gasoline

(75) Inventor: William A. Hubbard, Williamsburg, VA (US)

(73) Assignee: Leonard Bloom

(21) Appl. No.: 12/799,886

(22) Filed: May 4, 2010

Related U.S. Application Data
(63) Continuation-in-part of application No. 12/229,520, filed on Aug. 22, 2008, now Pat. No. 7,735,460.
(60) Provisional application No. 61/339,186, filed on Mar. 1, 2010.

(51) Int. Cl. F02P 3/00

(52) U.S. Cl. 123/595

(57) ABSTRACT

The conventional spark plug (or plugs) of a spark-fired gasoline engine are removed and replaced with a high-power spark plug (or plugs) capable of delivering very high power (e.g., one megawatt) over a relatively-narrow time interval (e.g., 20 nanoseconds). Next, the gasoline is replaced with a readily-available non-volatile fuel (e.g., JP-8). The gasoline—and its transportation, storage, handling and/or use—is eliminated altogether, thereby removing a strategic and tactical threat from enemy and terrorist forces who otherwise would be targeting the gasoline tanks or transports. Additionally, or alternatively, the fuel in the line (or the fuel injector) may be heated to start a cold engine or under cold ambient temperatures. The invention is also applicable to consumer products (e.g., lawnmowers) where the extra expense of occasional use is a tradeoff for safety and convenience.

### CROSS REFERENCE TO RELATED APPLICATIONS

The present invention is a continuation-in-part (CIP) of allowed application Ser. No. 12/229,520 filed Aug. 22, 2008, and incorporates in its entirety the subject matter of provisional patent application Ser. No. 61/339,186 filed Mar. 1, 2010, by reference herein.

### FIELD OF THE INVENTION

The present invention relates to spark-fired gasoline engines and, more particularly, to a method and apparatus for eliminating the gasoline and starting and running the engine smoothly on a variety of non-volatile fuels, many of which are readily available, and without regard for respective octane numbers.

### BACKGROUND OF THE INVENTION

I am the (joint) inventor of a number of United States patents disclosing the method and composition of an emergency fuel in the event a motorist runs out of gas on the road. Various compositions were disclosed including, for example, a blend of aromatic and aliphatic mineral spirits (akin to paint thinners) and the resulting product was sold under the trademark “SPARE TANK”. The applicable patents are as follows—

| No. | Issue Date |
|---|---|
| 5,681,358 | Oct. 27, 1997 |
| 5,853,433 | Dec. 29, 1998 |
| 5,938,799 | Aug. 17, 1999 |
| 6,110,237 | Aug. 29, 2000 |
| 6,113,660 | Sep. 05, 2000 |

and their disclosures and teachings are incorporated by reference herein in their entirety.

Since then, I have learned of an interesting development in the automotive industry, namely, a high-power spark plug marketed by Enerpulse, Incorporated of Albuquerque, N. Mex. under the trademark “PULSTAR”. This product has been disclosed in the following published patent applications—
US 2007/0262721 Published 15 Nov. 2007
US 2008/0018216 Published 24 Jan. 2008
   the respective disclosures and teachings of which are incorporated by reference herein in their entirety.

This “PULSTAR” spark plug is intended for automobiles and other vehicles and its purpose is to improve engine efficiency, acceleration, power, and gas mileage in standard cars. Their marketing focus is the automobile aftermarket and, eventually, the O.E.M. market. All of their published research and development has been directed to gas-guzzling cars, and there has been no hint or suggestion that this product could be used—not with gasoline—but with non-volatile fuels for an entirely different purpose.

In a completely different “orbit”, for many years the military has been concerned with the transport, storage, handling and use of gasoline for powering certain vehicles and other peripheral equipment using gasoline engines. It is a huge strategic and tactical problem, especially in battlefield conditions and war zones.

For example, the United States Army has brought in gasoline in tanker trucks from Kuwait to Baghdad in large convoys guarded by troops and/or contractor personnel. These convoys of tanker trucks are very inviting targets for terrorists, insurgents and enemy forces.

The Navy, on the other hand, has used certain types of equipment (powered by gasoline engines) in Naval shipyards and on the ships at sea, including carriers. To power this equipment, the carrier had a large tank or tanks to store the gasoline, and a direct hit on those tanks by a cruise missile or torpedo could completely disable the ship. To alleviate or eliminate this tactical disadvantage, the Navy has now largely switched to diesel engines; but diesels are traditionally heavy and more expensive than spark-fired gasoline engines. In an attempt to minimize this consequential problem, I have learned that R & D efforts are being directed to produce a compact diesel engine. Other R & D efforts have been directed to improved fuel cells.

Despite this extensive research and development conducted by the military, I am not aware of any instance where the military has found a way to completely eliminate the gasoline altogether, and to power typical gasoline engines with a substantially non-volatile fuel and, especially, a fuel that is readily available. Typical of such military fuels are JP-4, JP-8 and Jet A1; presently, JP-8 is very heavily used.

A fairly recent article in TIME magazine (Dec. 7, 2009, page 18) stated that each USA soldier in Afghanistan consumes, on the average, around twenty-two (22) gallons of fuel a day, and that the fuel costs around forty-five dollars ($45) per gallon, which is roughly one thousand dollars ($1,000) per day per soldier—a truly astounding figure! With around 70,000 troops in Afghanistan and another 30,000 being mobilized—a total of around one hundred thousand (100,000) troops—that amounts to a fuel cost of one hundred million dollars ($100,000,000) per day! Times 365 days, that amounts to 36.5 billion dollars per year!

Why does the fuel cost around $45 per gallon? Why so high?

TIME reports that the fuel costs $2.14 per gallon; that the logistics (delivery, etc.) costs $4.83 per gallon; and that the balance of $37.54—a whopping eighty-three percent (83%) of the cost—is for protection, which is likely contractor-hired convoys to support and protect the transport and logistical operations.

The percentage of fuel consisting of gasoline or other highly volatile fuels is not known—it's likely classified information—but assuming, for example, it's one-third (⅓) of the total; and further assuming that using my invention, the military could cut its “protection” costs in half (½), that could result, potentially, in a gross cost reduction of upwards of around six billion dollars ($6,000,000,000) per year (minus, of course, the costs of retrofitting the existing spark-fired gasoline engines out in the field as well as any incremental cost of the fuel compared to gasoline). However, those retrofit costs to implement my invention, in comparison to the huge potential cost reduction, would be relatively minimal.

Even more importantly, the risk to life or limb of our brave soldiers and/or their civilian counterparts (contractor employees) would be substantially reduced if not eliminated altogether.

Thus, to remove the strategic and tactical threat while simultaneously greatly simplifying the logistics—and especially substantially reducing the protection which is currently employed—it would be very desirable to power the existing gasoline-driven engines by using a standard widely-used non-volatile fuel, such as JP-8, and to provide a relatively simple retrofit kit that can be implemented out in the field.

There is also, potentially, a huge industrial and/or consumer market for eliminating the gasoline and operating spark-fired gasoline engines—in lawnmowers, small tractors, chainsaws, leaf blowers, weed trimmers, generators, etc.—with a combination of SPARE TANK and PULSTAR (or their respective equivalents). In my humble opinion, there is a potential consumer market—a fair slice of the “Harry Homeowners” of the world—who will pay a premium for convenience and safety and eliminate altogether that little red can or container (half filled with gasoline) that is traditionally stored in the garage.

### SUMMARY OF THE INVENTION

Accordingly, I have bridged these two separate and distinct technologies. First, I realized that I could modify a standard gas engine by removing its conventional spark plug and substituting the special “PULSTAR” high-power spark plug (normally used for an altogether different purpose). Second, I could eliminate the gasoline and substitute a non-volatile fuel. So, I could achieve the best of both worlds. As a result, I could eliminate a serious strategic and tactical problem for the military and security forces; simplify their logistics by using a standard non-volatile fuel; start a cold engine or under cold ambient temperatures; and maintain the reliability of their gasoline-engine driven equipment. Moreover, my invention could be the ideal entrée for a huge latent industrial, commercial and/or consumer market.

In accordance with the teachings of the present invention, I have herein disclosed the method of operating a spark-fired gasoline engine in equipment such as that used by the military and/or security services, including the steps of replacing the conventional spark plug with a high-power spark plug capable of delivering a substantially high amount of power over a substantially narrow time interval; and replacing the gasoline with a readily-available substantially non-volatile fuel having a substantially-high flash point. The fuel is relatively safe to transport, store, handle and/or use, thereby greatly simplifying logistical problems while eliminating the necessity for transporting, storing, handling and/or using gasoline, and thereby eliminating an inviting target for enemy and/or terrorist forces. The fuel will be ignited by the high-power spark plug even though the engine and/or the ambient temperature is relatively cold.

In a preferred embodiment, the high-power spark plug delivers approximately 1 megawatt of power over approximately 20 nanoseconds.

In one embodiment, the high-power spark plug has a modified gap in the range of approximately 1/16 to 3/16 of an inch.

The non-volatile fuel may comprise mineral spirits and aromatics or, possibly, selected from the group comprising jet fuels, diesel, vegetable oils, algae and/or mixtures thereof and/or additives thereto.

Any non-volatile fuel may be used, such as mineral spirits and aromatics, provided that the fuel has a sufficiently low flashpoint, such that a cold engine may be started even in a moderately cold ambient temperature and run smoothly without substantial knocking. Preferably, and to maintain non-volatility, the flashpoint should be above 100° F. (approximately).

Also, and in an interesting embodiment of my invention, the non-volatile fuel may comprise shale oil or mixtures thereof. Shale oil—according to current estimates—is quite plentiful in the United States, relatively easy to obtain, and may be generally competitive with gasoline.

Viewed in another aspect, I have disclosed the combination of a spark-fired gasoline engine having one or more spark plugs which are capable of delivering a substantially-high amount of power over a substantially-narrow time interval, and a substantially non-volatile fuel having a sufficiently low flashpoint to maintain non-volatility and yet sufficiently high for ignition purposes. The fuel is relatively safe to transport, store, handle and/or use, thereby eliminating the necessity for transporting, storing, handling and/or using gasoline, and thereby eliminating an inviting target for enemy and/or terrorist forces. The fuel will be ignited by the spark plug even though the engine and/or the ambient temperature is relatively cold.

Viewed in yet another aspect, the present invention also provides a retrofit kit for a spark-fired gasoline engine out in the field, including one or more high-power spark plugs intended to replace the conventional plugs in the engine. A supply of a substantially non-volatile fuel is provided, having a sufficiently low flashpoint for ignition purposes and yet a sufficiently high flashpoint to maintain non-volatility such that the non-volatile fuel may be used to start a cold engine and run the engine smoothly and without substantial knocking, thereby eliminating the use of potentially dangerous gasoline.

In a preferred embodiment of the retrofit kit, the high-power spark plugs are capable of delivering 1 megawatt of power at around 20 nanoseconds; and the non-volatile fuel is selected from the group comprising mineral spirits and aromatics, jet fuels, diesel, vegetable oils, shale oil, algae and/or mixtures thereof and/or additives thereto.

Moreover, to further assure reliability of the equipment (with or without the high-power “PULSTAR” plug) I can heat the fuel in the line just ahead of the fuel injection and/or include a heating coil or other heating element in the base of the injector—as disclosed and claimed in my U.S. Pat. No. 6,334,418 issued on Jan. 1, 2002, the disclosure and teachings of which are incorporated by reference herein in their entirety.

Thus, in addition to my basic invention, I have assembled and bridged three readily-available technologies—
1) The “PULSTAR” high-powered spark plug intended to improve power, acceleration and gas mileage in automobiles and other vehicles;
2) The readily-available widely-used non-volatile fuels (e.g., JP-8); and
3) My own U.S. Pat. No. 6,334,418 for heating the fuel or the fuel injector.
   and as a result, I have solved a nagging long-standing strategic and tactical problem heretofore encountered, tolerated and guarded against by our military and security forces.

These and other objects of the present invention will become apparent from a reading of the following specification, taken in conjunction with the enclosed drawings.

### BRIEF DESCRIPTION OF THE DRAWINGS

FIG. 1 is a method flow chart to implement the present invention.

### GENERAL DESCRIPTION OF THE PREFERRED EMBODIMENTS

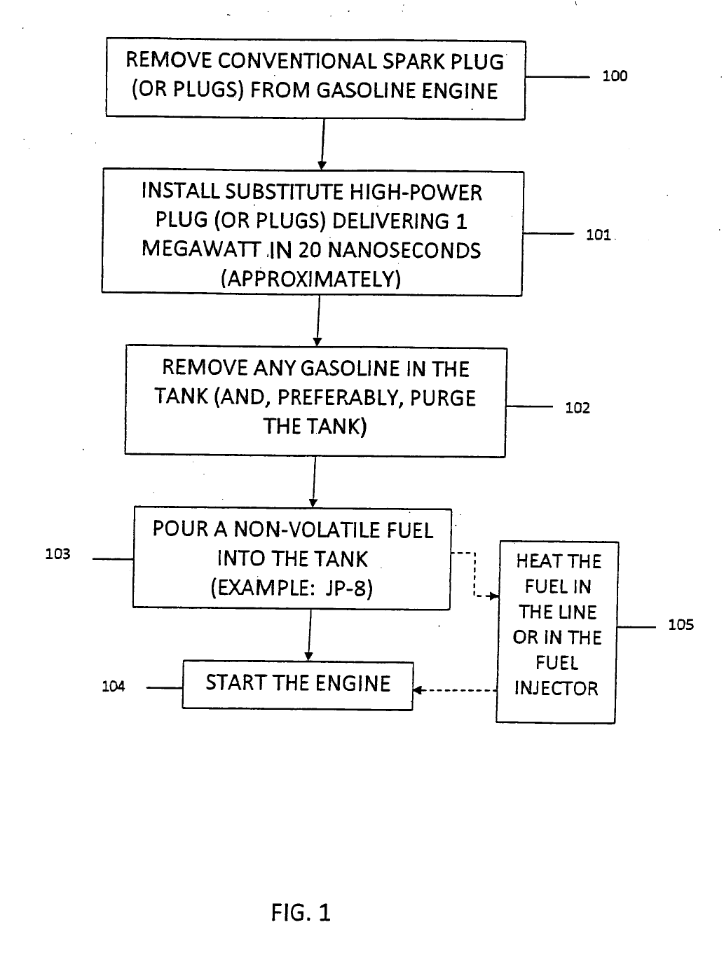

With reference to FIG. 1, the existing spark plug (or plugs) in a gasoline engine-driven piece of equipment—such as that used by the military or security forces—is removed at Step 100—and replaced with a readily-available relatively high-power spark plug (at Step 101), such as the spark plug marketed under the trademark “PULSTAR” by Enerpulse, Incorporated located in Albuquerque, N. Mex. (or any equivalent high-power spark plug). The “PULSTAR” plug claims output power of one megawatt at 20 nanoseconds.

In Step 102, the gasoline is drained or removed out of the gas tank and, preferably, the tank is purged of gasoline. A non-volatile fuel (e.g. JP-8 jet fuel) is poured into the tank (Step 103) and the engine is started (Step 104). If necessary or desirable, the fuel in the line may be heated or the fuel injector heated (Step 105) per my earlier '418 patent, as disclosed hereinafter.

In a preliminary experiment, I retrofitted an existing gasoline lawn mower engine by substituting a “PULSTAR” plug for the mower's conventional plug and by filling the tank with my patented “SPARE TANK” fuel having a flashpoint of about 105° F.; and the (cold) engine fired up immediately and ran smoothly without knockup.

In a later experiment, however, again with a cold engine and pouring Jet-A1 fuel—similar to JP-8—into the tank, the cold engine did not start immediately. So, I drained out the Jet-A1, poured in some gasoline, and started the engine to warm it up. Thereafter, the gasoline was used up and drained out and Jet-A1 was added to the tank; the warm engine fired up immediately and operated smoothly despite the relatively low octane number of the Jet-A1 fuel.

I then realized that my retrofit kit, if necessary or desirable, could include a heater for the fuel line between the fuel reservoir and the ignition chamber or a heating element in the fuel injector directly—basically a modified fuel injector as disclosed and taught in my U.S. Pat. No. 6,334,418—the disclosure and teachings of which are incorporated by reference herein in their entirety. As disclosed therein, the heating is stopped after the engine warms up sufficiently.

The main thrust of my '418 patent was to facilitate the use of alternative fuel in automobiles, such as the use of my “SPARE TANK” fuel. Others in the industry have heated fuel injectors to reduce pollution during engine warm-up. Again, their purpose was environmental, and not to facilitate the use of JP-8 (or other standard jet fuels used by the military) so as to eliminate the gasoline altogether for improved security.

Accordingly, I have discovered that by retrofitting the gasoline engines out in the field by using a “PULSTAR” plug (or its equivalent)—and/or by retrofitting the engine with a heated fuel injector—the military and/or security forces can use a readily-available widely-used non-volatile fuel, such as JP-8. I can thereby completely eliminate the strategic and tactical threat characterized by storage tanks of gasoline in our military and internal security installations and on board the aircraft carriers and other ships at sea. Moreover, the logistics are simplified by completely eliminating one of the supply lines (namely, the supply of gasoline). So there is an economic benefit commensurate with increased security for our troops and/or contractor personnel.

Jet fuels, such as JP-8, have an inherently low octane number (around 30 or so) but, traditionally, octane ratings are not really significant for jet fuels. Conversely, petroleum researchers, automotive engineers, or the designers of various types of gasoline-engine driven equipment—and indeed the general public—would never think of using the jet fuels (such as JP-8) because of their inherently low octane ratings. They would all know that it wouldn't work. You can't do that. The engine would continue to knock and could literally shake itself to pieces.

I have discovered, however, that by using my invention—combining JP-8 with “PULSTAR” (or its respective equivalent)—the pre-heated gasoline engine runs smoothly. It purrs like a kitten.

Of course, it will be understood that other non-volatile fuels may be used (as previously noted herein) and with or without certain additives and depending upon the economics and other factors and considerations.

There is also the potentially-huge consumer market. For example, “Harry Homeowner” could purchase a retrofit kit containing “PULSTAR” and “SPARE TANK” (or their respective equivalents) and—in a matter of a few minutes—easily change the plug on his lawnmower, fill up the tank with “SPARE TANK” (or an equivalent non-volatile fuel) and fire up his mower. Thereafter, a “3-pack” or a “6 pack” of a non-volatile fuel could be delivered to him (e.g., via UPS) to his door. There would be no necessity for running back and forth to his nearest gas station to fill up his little red can and, indeed, that can could be thrown away (of course, in an appropriate environmental manner).

Obviously, many modifications may be made without departing from the basic spirit of the present invention. Accordingly, and within the scope of the appended claims, the present invention may be practiced other than specifically disclosed herein.

1. A retrofit kit for a spark-fired gasoline engine out in the field, comprising one or more high-power spark plugs, such that said high-power spark plugs may replace the conventional plugs in the engine, and a supply of a substantially non-volatile fuel, such that said non-volatile fuel may be used to start a cold engine and run the engine smoothly without substantial knocking, thereby eliminating the use of dangerous gasoline.

2. The retrofit kit of claim 1, wherein said high-power spark plugs are capable of delivering 1 megawatt or more of power in around 20 nanoseconds.

3. The retrofit kit of claim 1, wherein the non-volatile fuel is selected from the group comprising mineral spirits and aromatics, jet fuels, diesel, algae and/or vegetable oils, shale oil, and/or mixtures thereof and/or additives thereto.

4. The retrofit kit of claim 1, wherein the fuel has a flashpoint which is sufficiently low for ignition purposes yet sufficiently high to maintain non-volatility.

5. The retrofit kit of claim 4, wherein the flashpoint is approximately 100° F. or higher.

6. The method of operating a spark-fired gasoline engine in equipment such as that used by the military and/or security services, comprising the steps of replacing the conventional spark plug with a high-power spark plug capable of delivering a substantially high amount of power over a substantially narrow time interval, and replacing the gasoline with a readily-available substantially non-volatile fuel having a substantially high flash point, such that the fuel is relatively safe to transport, store, handle and/or use, thereby simplifying logistical problems while eliminating the necessity for transporting, storing, handling and/or using gasoline, and thereby eliminating an inviting target for enemy and/or terrorist forces, and such that the fuel will be ignited by the high-power spark plug even though the engine and/or the ambient temperature is relatively cold.

7. The method of claim 6, wherein the high-power spark plug delivers approximately 1 megawatt or more of power over approximately 20 nanoseconds.

8. The method of claim 7, wherein the high-power spark plug has a gap in the range of 1/16 to 3/16 of an inch.

9. The method of claim 6, wherein the fuel comprises a jet fuel and is selected from the group comprising JP-4, JP-8 and Jet A1.

10. The method of claim 9, wherein the fuel comprises JP-8.

11. The method of claim 6, wherein the engine includes a fuel reservoir, an ignition chamber, and a line therebetween, and wherein the fuel is heated in the line to the ignition chamber.

12. The method of claim 11, wherein the engine includes a fuel injector, and the fuel is heated in the fuel injector.

13. The method of claim 12, wherein the heating of the fuel is discontinued after the engine warms up.

14. The combination of a spark-fired gasoline engine, wherein the engine has one or more spark plugs capable of delivering a substantially high amount of power over a substantially narrow time interval, and a fuel having a substantially high flashpoint to maintain non-volatility, such that the fuel is relatively safe to transport, store, handle and/or use, thereby eliminating the necessity for transporting, storing, handling and/or using gasoline, and such that the fuel will be ignited by the one or more spark plugs even though the engine and/or the ambient temperature is relatively cold.

15. The method of operating equipment normally powered by a gasoline engine having one or more conventional spark plugs with one or more special spark plugs normally intended to be used in vehicles to improve engine performance and gas mileage and capable of delivering relatively-high amounts of energy over a relatively-small time period, thereby retrofitting the engine, purchasing a non-volatile fuel shipped via conventional channels of distribution and taking delivery directly at the customer's or user's home or place of business or at a convenient retail location, and pouring the non-volatile fuel into the gas tank of the equipment; thereby eliminating the use of gasoline such that the engine will start and run smoothly, and thereby substantially improving user safety and convenience.

16. The method of claim 15, wherein the one or more special spark plugs are capable of delivering approximately one megawatt of power within approximately 20 nanoseconds.

17. The method of claim 15, wherein the non-volatile fuel comprises mineral spirits and aromatics.

18. The method of claim 15, wherein the non-volatile fuel is shipped via FED-X, UPS or the Postal Service.

19. The method of operating a spark-fired gasoline engine by employing a spark plug or plugs and/or an ignition system which is capable of delivering a relatively high amount of power over a relatively small time period, employing a non-volatile fuel having a relatively high flashpoint; wherein the ambient temperature and/or the temperature of the ignition chamber of the engine is above the flashpoint of the fuel; and wherein if the ambient temperature and/or the temperature of the ignition chamber of the engine is below the flashpoint of the fuel, the ambient temperature and/or the temperature of the ignition chamber and/or the fuel is heated to a temperature above the flashpoint of the fuel, thereby assuring that the engine will start and run smoothly without substantial knocking and without particular concern for the octane rating of the fuel, and thereby substantially eliminating the potential danger associated with the transport, storage, handling and/or use of gasoline.

20. The method of claim 19, wherein the spark plug or plugs is capable of delivering around one megawatt in around 20 nanoseconds.

21. The method of claim 19, wherein the ignition system includes an ignition coil disposed externally of the spark plug or plugs.

22. The method of claim 19, wherein the non-volatile fuel is selected from the group comprising mineral spirits and aromatics, vegetable oil, shale oil, diesel, and jet fuel and mixtures thereof.
